(19) United States
(12) Patent Application Publication
(10) Pub. No.: US 2022/0298353 A1
(43) Pub. Date: Sep. 22, 2022

(54) MOLDING MATERIAL

(71) Applicant: WAXELL GMBH, Wien (AT)

(72) Inventors: Claus STEFANSKI, Wien (AT); Friedrich BREIDENBACH, Wien (AT)

(73) Assignee: WAXELL GMBH, Wien (AT)

(21) Appl. No.: 17/638,378

(22) PCT Filed: Aug. 26, 2020
(86) PCT No.: PCT/EP2020/073807

§ 371 Date: Feb. 25, 2022

(30) Foreign Application Priority Data
Sep. 12, 2019 (AT) A 50794/2019

(51) Int. Cl. C08L 91/06; B29C 67/24; B29C 70/58

(52) U.S. Cl. CPC C08L 91/06; B29C 67/241; B29C 70/58; C08L 2203/30; C08L 2205/16; B29K 2091/00

(57) ABSTRACT

The invention relates to a molding material, consisting of or comprising an organic binder, the organic binder being a wax or comprising a wax; and a filler mixture, the filler mixture comprising or consisting of a mineral filler and a fibrous material, wherein the wax is contained in the molding material in a content of between 3% by weight and 23% by weight, and wherein the mineral filler is contained in the molding material in a content of between 75% by weight and 95% by weight. The invention further relates to a molded part made of such a molding material, a method for producing a molded part, and the use of a molding material for forming a molded part.

### CROSS-REFERENCE TO RELATED APPLICATION(S)

This application is the National Stage of International Patent Application No. PCT/EP2020/073807 filed on Aug. 26, 2020, which claims priority from Austrian Patent Application No. A50794/2019 filed on Sep. 12, 2019, both of which are hereby incorporated by reference herein in their entireties.

### BACKGROUND

The present invention relates to a molding material according to the preamble of the independent patent claim, a molded part made of this molding material, a method for producing the molded part, and the use of the molding material for forming a molded part.

Packaging materials are used in many areas, for example in the food industry or in the cosmetics industry. Packaging materials, in particular containers, are often made of plastics, ceramic materials or glass.

Among these, plastic has the disadvantage that often no renewable raw materials are used for production and thus products from the petroleum industry are used, which have a negative impact on the greenhouse gas balance. In addition, plastics have the disadvantage that they do not convey a high-quality feel to the consumer due to their low density, which is particularly problematic in the case of packaging for luxury products, such as high-quality cosmetics or perfumes.

Between the years 1950 and 2015, around 8.3 billion tons of plastic were produced worldwide—almost half of it since 2000. By 2025, more than 600 million tons of plastic are expected to be produced annually. The increasing demand for plastic inevitably leads to disposal issues and environmental problems, especially because current estimates suggest that about 40% of plastic products are waste after less than a month.

The worldwide consumption of rigid plastic packaging is equivalent to about 52.9 million tons in 2017 and is subject to an annual growth of about 3.7%. Western Europe accounts for about 20% of the world market. In 2016, Austrians produced about 34 kilograms packaging waste per capita. This put them among the European leaders and above the EU average of 32 kilograms.

In order to avoid the disadvantages of plastics, which are produced using petroleum-based raw materials, bioplastics are used. The Plastics Europe's Market Research Group (PEMRG) estimates that currently 6% of all plastic packaging are made of bioplastics. European Bioplastics (EUBP) assumes that the worldwide production of bioplastics will rise by 18.8 percent from 2017 to 2022.

A particular problem in using plastics of all kinds is their disposal. Most kinds of plastic are very durable and using them for non-durable packaging proves to be problematic, in particular when the plastic materials end up in the environment. Over the years, plastics break down into increasingly smaller pieces—first into microplastic, and finally into nanoplastic. At present, it is assumed that even microorganisms are not able to entirely decompose plastics. In addition, harmful substances may be released from the material.

According to calculations of the EU commission, every year an estimated total of 75,000 to 300,000 tons of microplastics end up in the environment in the European Union, where it can not only be detected in the oceans, but now also in remote areas such as in the Arctic or in the Swiss mountain regions.

Other examples of frequently used packaging materials, in particular of containers of various kinds, are glass and ceramics. While these materials present a high density and thus convey a high-quality feel for the consumer, their processing is energy consuming and costly. In particular, the melting of the starting materials for the production of glass containers and the sintering of ceramic materials are carried out at high temperatures, which requires a high energy input.

The use of packaging with a high-quality feel is of particular interest in the cosmetics industry. Cosmetics companies in the luxury segment demand high-quality packaging with high weight and possibly unique characteristics. In order to reach the high weight, the walls of cream pots are made especially thick, and the base region is often doubled. Incorporating metal powders into plastics is also common in order to give more weight. Since cream pots are usually composed of multiple components made of different plastics, at the present time recycling is only possible at great expense or not at all.

### SUMMARY

In order to overcome the disadvantages of the prior art, an object of the present invention is to create a molding material which can be produced from renewable raw materials and conveys a high-quality hand feel and pleasant haptics. In addition, the molding material is to be processable with low energy requirements and is to be recyclable.

This object is solved by a molding material according to the independent patent claim.

The invention relates to a molding material consisting of or comprising:

an organic binder, the organic binder being a wax or comprising a wax, and

a filler mixture, the filler mixture comprising or consisting of a mineral filler and a fibrous material.

The invention provides that the molding material contains between 3% by weight and 23% by weight of the wax, and in that the molding material contains between 75% by weight and 95% by weight of the mineral filler.

It has surprisingly been found that molding materials with particularly high contents of mineral fillers can be processed by using wax as a binder. The high content of mineral fillers gives the molding material a particularly high density, in particular more than 1.5 g/cm³, more preferably more than 2.0 g/cm³. As a result, containers made of such a molding material have a particularly high-quality feel and are thus also suitable for use in the packaging of luxury products. Also, the hand feel of a molded part of such a molding material meets the common high demands.

The fibrous material increases the breaking strength of the molded part made of the molding compound.

The molding compound according to the invention has several advantages over the materials known from the prior art, in particular over plastic or glass.

Since waxes instead of polymer materials are used as binders, no microplastics can be produced after disposal. The components of the molding compound may preferably be selected such that their recovery is not in competition with food or animal feed production. Optionally, materials may be used which are by-products of the food production. An example of this is rice wax.

Preferably, the molding compound according to the invention is free of plasticisers and other potentially harmful substances.

The molding compound according to the invention and molded parts made therefrom are degradable or decomposable in nature. Even when introduced into the environment, recycling into natural cycles is possible.

Molded articles made of a molding compound according to the invention optionally have a considerably better environmental footprint compared to plastics.

In the context of the present invention, the term “wax” means a mixture of organic compounds or a single organic compound which is solid or kneadable at room temperature and melts at elevated temperature, in particular above 40° C. Molten waxes form liquids with low viscosity. It is assumed that the low viscosity of the molten waxes facilitates the blending ability of the filler mixture with the binder.

For example, waxes may be aliphatic alcohols (more than 6 carbon atoms, in particular more than 10 carbon atoms), aliphatic carbonic acids, ketones and long-chain hydrocarbons or a mixture of several of these substances.

Optionally, the organic binder of the invention is a liquid without any solids suspended therein at a temperature between 50° C. and 150° C., preferably between 70° C. and 120° C. Preferably, the organic binder is free of polymers.

The wax may be one or more from the following group: vegetable wax, animal wax, mineral wax, synthetic wax. Examples of vegetable waxes are rice wax, castor wax, sunflower wax, sugarcane wax, carnauba wax and candelilla wax. Examples of animal waxes are wool wax and beeswax. Examples of mineral waxes are paraffin wax and montan wax. An example of a synthetic wax is stearin. Synthetic waxes may also comprise semi-synthetic waxes made from natural products through a chemical conversion step. For example, stearin may be obtained from the saponification of vegetable oils. Preferred waxes are vegetable waxes.

Preferably, the mineral filler is not water-soluble and/or not soluble in the binder. “Not soluble” or “insoluble” might mean that a substance dissolves in a liquid in a concentration of at most 0.1% by weight, preferably at a temperature of about 20° C.

Optionally, the mineral filler is selected from one or more water-insoluble alkali and/or alkaline earth metal compounds. The mineral filler may be produced synthetically or obtained from a natural raw material, such as rocks. A preferred mineral filler is a magnesium or calcium compound, especially preferably calcium carbonate.

Other usable mineral fillers are unburnt plaster, basalt, pumice, dolomite, glass, garnet, granite, wood ash, kaolin powder, bone ash, marble, meerschaum, quartz, fire clay, whiting, silica, talc, volcanic ash, wollastonite, barium sulfate, bentonite, mica, montmorillonite, barite.

Preferably, the fibrous material is not water-soluble and/or not soluble in the binder.

The molding material may contain between 1% by weight and 15% by weight of the fibrous material. A preferable content of the fibrous material is between 1% by weight and 7% by weight. A fibrous material according to the present invention may be a material with a higher expansion in one spatial direction than in the other two spatial directions. A fibrous material may also present in particular elongated aggregates with an anisotropy in one spatial direction.

The fibrous material may be one or more from the following group: natural fibers, in particular cellulose fibers, synthetic fibers, textile fibers, paper fibers, recycled fibers. Preferred fibrous materials are natural fibers, such as bagasse, wood, cotton, hemp, flax, kenaf, coconut, pineapple, palm, banana, water hyacinth, sea grass, bamboo, reed, grass, straw, rice husks, bast or cotton linter. Optionally, the fibrous material may comprise waste material such as pre-consumer waste like lyocell fibers or modal fibers.

The fibrous material may also comprise or consist of fibrillated fibers.

The length of the fibers, in particular their average length, is optionally less than 10 mm, preferably less than 2 mm. Particularly preferably, it is between 100 μm and 1000 μm.

Optionally, the filler mixture has a melting point of more than 150° C., preferably more than 200° C. This prevents the filler mixture from melting at the usual processing temperatures of the molding compound.

In a preferred embodiment, the molding material comprises:

75% by weight to 85% by weight calcium carbonate,

10% by weight to 20% by weight wax, in particular carnauba wax and/or rice wax, and

1% by weight to 5% by weight cellulose fibers.

Optionally, the molding compound is made of at least 95% by weight, preferably entirely, natural and/or renewable raw materials.

If appropriate components are used, the inventive molding compound is non-toxic in production and use, non-phytotoxic and free of harmful substances.

The inventive molding compound is substantially completely recyclable. In a recycling process, a molded article can be melted. Subsequently, the individual components can be separated, for example by sieving, filtering, density separation, and the like. The individual components may be returned to the production process after appropriate purification steps.

The invention further relates to a molded part comprising or consisting of a molding material according to the invention. Optionally, the molded part is a container.

The invention further relates to a method for producing a molded part from a molding material according to the invention, the method comprising the following steps:

forming a moldable mass by heating the molding material to a temperature between 50° C. and 150° C., preferably between 70° C. and 120° C.,

shaping the mass into a molded part, and

cooling the mass for solidifying the molding material.

The shaping of the mass may in particular be done by shell casting, injection molding, transfer molding, extrusion, deep-drawing, calendering, rotational molding, pressure bag molding or compression molding. A preferred molding process is injection molding.

The invention further relates to the use of a molding material according to the invention for forming a molded part.

Further features of the invention arise from the patent claims and the exemplary embodiment. In the following, the present invention is described in detail on the basis of an exemplary embodiment.

### DETAILED DESCRIPTION OF EXEMPLARY EMBODIMENT(S)

### Example

In an exemplary embodiment, the production of a storage box made of a molding material composition according to the invention is described.

The molding material has the following composition: 80% by weight calcium carbonate as mineral filler, 17% by weight rice wax as organic binder and 3% by weight cellulose fibers. The calcium carbonate (food grade, >99%) is a powder presenting an average particle diameter of about 90 μm. The cellulose fibers are wood fibers presenting an average length of about 200 μm.

After mixing the components, the mixture is heated to approx. 90° C. to melt the organic binder and form a moldable mass. In a mixing device, the molding material is mixed to homogeneity and subsequently introduced into an injection mold. The mixing device is a compounding apparatus typically used in the plastic industry. The injection mold comprises the mold for a container and the mold for a corresponding screw cap.

After solidification of the molding compound at a temperature of the mold of less than 50° C., the molded products can be removed from the mold. The wax content in the molding compound ensures an easy demolding even without the use of a release agent.

The material of the obtained container has a density of about 2.3 g/cm³. As a result, it conveys a high-quality hand feel and may be used for packaging high-quality cosmetic products.

The material of the container is completely recyclable. Since substantially no chemical crosslinking reactions take place when processing the molding compound, the material is re-meltable. Due to the low melting temperature of the wax, the energy consumption is low, yet safe usability is ensured at common use temperatures.

1. A molding material comprising:
an organic binder, the organic binder being a wax or comprising a wax, and
a filler mixture, the filler mixture comprising a mineral filler and a fibrous material,
wherein the molding material contains between 3% by weight and 23% by weight of the wax, and
wherein the molding material contains between 75% by weight and 95% by weight of the mineral filler.

2. The molding material according to claim 1, wherein:
the wax is selected from the group consisting of: vegetable wax; rice wax; castor wax; sunflower wax; sugarcane wax; carnauba wax; candelilla wax; animal wax; wool wax; beeswax; mineral wax; paraffin wax; montan wax; synthetic wax; and stearin.

3. The molding material according to claim 1, wherein:
the mineral filler is selected from the group consisting of: water-insoluble alkali; and alkaline earth metal compounds.

4. The molding material according to claim 3, wherein:
the mineral filler comprises calcium carbonate.

5. The molding material according to claim 1, wherein:
the molding material contains between 1% by weight and 15% by weight of the fibrous material.

6. The molding material according to claim 1, wherein:
the fibrous material is selected from the group consisting of: natural fibers; cellulose fibers; synthetic fibers; textile fibers; paper fibers; and recycled fibers.

7. The molding material according to claim 6, wherein:
the fibrous material is a natural fiber selected from the group consisting of: bagasse; wood; cotton; hemp; flax; kenaf; coconut; pineapple;
palm; banana; water hyacinth; sea grass; bamboo; reed; grass; and straw.

8. The molding material according to claim 1, wherein:
the length of the fibers is less than 10 mm.

9. The molding material according to claim 1, further comprising:
75% by weight to 85% by weight calcium carbonate,
10% by weight to 20% by weight wax, and
1% by weight to 5% by weight cellulose fibers.

10. A container, comprising a molding material according to claim 1.

11. A method for producing a molded part, comprising:
providing or obtaining the molding material according to claim 1,
forming a moldable mass by heating the molding material to a temperature between 50° C. and 150° C.,
shaping the moldable mass into a molded part, and
cooling the moldable mass for solidifying the molding material.

12. The method according to claim 11, wherein:
the shaping of the moldable mass is done by one or more of: shell casting; injection molding; transfer molding; extrusion; deep-drawing; calendering; rotational molding; pressure bag molding; compression molding.

13. (canceled)

14. The molding material according to claim 1, wherein:
the length of the fibers is less than 2 mm.

15. The molding material according to claim 1, wherein:
the length of the fibers is between 100 μm and 1000 μm.
